(19) United States
(12) Patent Application Publication
(10) Pub. No.: US 2015/0092888 A1
(43) Pub. Date: Apr. 2, 2015

(54) APPARATUS FOR TRANSMITTING AND RECEIVING A SIGNAL AND METHOD THEREOF

(71) Applicant: Kyungpook National University Industry-Academic Cooperation Foundation, Daegu (KR)

(72) Inventors: Dong Seog Han, Daegu (KR); Eun Su Kang, Daegu (KR)

(21) Appl. No.: 14/503,447

(22) Filed: Oct. 1, 2014

(30) Foreign Application Priority Data
Oct. 2, 2013 (KR) 10-2013-0117645

(51) Int. Cl. H04L 27/20; H04L 27/227

(52) U.S. Cl. CPC H04L 27/2067; H04L 27/227
USPC 375/308; 375/332

(57) ABSTRACT

An transmitting apparatus is provided. The transmitting apparatus includes a modulator which performs a QPSK-modulation for original data by using a different constellation combination pattern by predetermined unit, and a transmitter which transmits the QPSK-modulated data. Accordingly, BEP performance may be improved by transmitting additional data according to a constellation combination patter in hidden form.

### CROSS-REFERENCE TO RELATED APPLICATION

This application claims priority from Korean Patent Application No. 10-2013-0117645, filed in the Korean Intellectual Property Office on Oct. 2, 2013, the disclosure of which is incorporated herein by reference.

### BACKGROUND

1. Field

A method and an apparatus with the exemplary embodiments relate to an apparatus for transmitting and receiving a signal and a method thereof. In particular, exemplary embodiments relate to an apparatus which transmits and receives additional data by using a QPSK-based constellation, and a method thereof

2. Description of the Prior Art

A technology of modulation which is used in a digital communication system related to broadcasting and communication can be classified according to the number of transmitting channels being used. Among them, a technology of modulation which uses two transmitting channels is a QAM (Quadrature Amplitude Modulation), and a QPSK Quadrature Phase Shift Keying) which have a Re (Real) axis and an Im (Imaginary) axis on a signal constellation.

Recently, the technology of modulation which uses two transmitting channels such as the QAM or the QPSK which can variously change a capacity of transmission is mainly used.

Meanwhile, when a transmitting apparatus transmits original data in the digital communication system, a technology of transmitting additional data with the original data is required.

In addition, since a receiving apparatus recognizes original data and additional data as one data, the additional data should be separated from the original data by extracting the additional data. However, when the additional data was inappropriately extracted, the original data could not be extracted accurately because the QPSK constellation was not appropriately extracted.

Besides, in the process of transmitting the original data and the additional data, an error may be caused to the additional data due to an interference signal and a fading phenomenon of an electronic wave, and the error may affect the original data. Accordingly, a way to reduce errors which can be caused in the additional data is required.

### SUMMARY

Aspects of the exemplary embodiments relate to a transmitting and receiving apparatus which is able to improve a Bit Error Rate (BER) performance since it can transmit additional data in hidden form by using a constellation combination pattern where at least one constellation is combined, and a method thereof.

In addition, aspects of the exemplary embodiments relate to a transmitting and receiving apparatus which is able to reduce errors of additional data and extract the additional data accurately by a transmitting apparatus which channel-codes and transmits the additional data and by a receiving apparatus which decodes and encodes the additional data.

According to an exemplary embodiment, a transmitting apparatus includes a modulator which performs a Quadrature Phase Shift Keying (QPSK) modulation for original data by using a difference constellation combination pattern by predetermined unit, and a transmitter which transmits the QPSK-modulated data.

The transmitting apparatus may further include a pattern generator which generates a different constellation combination pattern by predetermined unit by combining a first constellation and a second constellation by the predetermined unit regardless of an order, and generates additional data according to the constellation combination pattern.

In this regard, the pattern generator may combine the first constellation and the second constellation by using a Walsh Code.

Meanwhile, the transmitting apparatus may further include a channel coder which channel-codes the generated additional data.

In addition, the modulator may generate the QPSK-modulated data by adding the channel-coded additional data to the original data.

Meanwhile, the modulator may map by 2-bit unit the original data to at least one symbol included in the first constellation and the second constellation respectively according to a combination order of the first constellation and the second constellation which constitute the constellation combination pattern. In this case, the first constellation may have a 45 degrees phase difference from the second constellation.

Meanwhile, a receiving apparatus according to an exemplary embodiment includes a receptor which receives a signal from a transmitting apparatus, an extractor which checks a plurality of symbols included in the signal, detects at least one constellation combination pattern according to the plurality of symbols, and extracts additional data according to the constellation combination pattern, and a demodulator which Quadrate Phase Shift Keying (QPSK)-demodulates the plurality of symbols according to at least the one constellation combination pattern.

A method of transmission according to an exemplary embodiment includes performing a QPSK-modulation by using a different constellation combination pattern by predetermined unit, and transmitting the QPSK-modulated data.

In addition, the method of transmission may further include generating a different constellation combination pattern by the predetermined unit by combining a first constellation and a second constellation by the predetermined unit regardless of an order, and generating additional data according to the constellation combination pattern.

In addition, the generating additional data may generate the constellation combination pattern by combining the first constellation and the second constellation by using the Walsh code.

Meanwhile, the transmitting method may further include channel-coding the generated additional data.

In this case, the QPSK-modulating may generate the QPSK-modulated data by adding the channel-coded additional data to the original data.

Meanwhile, the QPSK-modulating may map by 2-bit unit the original data to at least one symbol included in the first constellation and the second constellation respectively according to a combination order of the first constellation and the second constellation which constitute the constellation combination pattern.

In the meantime, a method of receiving a signal according to an exemplary embodiment includes receiving a signal from a receiving apparatus, checking a plurality of symbols included in the signal, detecting at least one constellation combination pattern according to the plurality of symbols, and extracting additional data according to the constellation combination pattern, and QPSK-modulating the plurality of symbols according to at least the one constellation combination pattern.

According to the present inventive concept, additional data may be transmitted in hidden form by using a constellation combination pattern where at least one constellation is combined. Accordingly, a bit error rate may be improved.

In addition, according to the present inventive concept, errors of additional data may be reduced and extracted accurately by a transmitting apparatus which channel-codes and transmits the additional data and by a receiving apparatus which decodes and encodes the additional data.

### BRIEF DESCRIPTION OF THE DRAWINGS

The above and/or other aspects of the present disclosure will be more apparent by describing certain present disclosure with reference to the accompanying drawings, in which:

FIG. 1 is a block diagram illustrating a transmitting and receiving system according to an exemplary embodiment;

FIG. 2A and FIG. 2B are block diagrams illustrating a detailed configuration of a transmitting and receiving system according to an exemplary embodiment;

FIG. 3A and FIG. 3B are views illustrating a constellation according to an exemplary embodiment;

FIGS. 4A to 4C are views illustrating a method of channel-coding additional data according to an exemplary embodiment;

FIG. 5 is a view illustrating a method of mapping original data by using a constellation combination pattern according to an exemplary embodiment;

FIG. 6 is a view illustrating a method of extracting additional data according to an exemplary embodiment;

FIG. 7 is a flow chart illustrating a method of transmitting a signal according to an exemplary embodiment;

FIG. 8 is a flow chart illustrating a method of receiving a signal according to an exemplary embodiment; and

FIG. 9 and FIG. 10 are graphs where a Bit Error Rate (BER) and Eb/N0 are measured when transmitting data according to a comparative example and exemplary embodiments.

### DESCRIPTION OF THE PREFERRED EMBODIMENT

Hereinafter, exemplary embodiments will be described in detail with reference to the accompanying drawings. In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

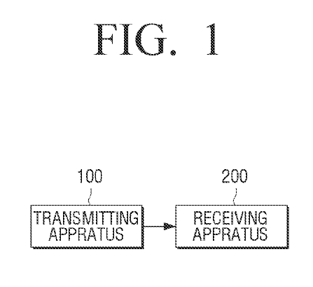

FIG. 1 is a block diagram illustrating a transmitting and receiving system according to an exemplary embodiment.

A transmitting and receiving system illustrated in FIG. 1 includes a transmitting apparatus 100 and a receiving apparatus 200. If the transmitting apparatus 100 transmits some kind of data to the receiving apparatus 200, the data may be modulated and transmitted. A modulation refers to a process of imagining data as a complex symbol which has a phase and a size. In this regard, the complex symbol may be shown as a constellation. In other words, the constellation is a drawing which represents a group of message dots (a complex symbol) corresponding to original data. In the present inventive concept, data may be modulated by using a QPSK-based constellation.

Specifically, the transmitting apparatus 100 may generate a constellation combination pattern, perform a QPSK-modulation for original data where additional data is added according to the constellation combination pattern, and transmit the QPSK-modulated data to the receiving apparatus 200. In this regard, the constellation combination pattern may be a combination of a first constellation and a second constellation by predetermined unit. Thus, if a constellation combination pattern is generated, additional data according to the constellation combination pattern may be generated. Accordingly, the additional data may be added and transmitted in hidden form to the QPSK-modulated data.

The receiving apparatus 200 receives a signal from the transmitting apparatus 100. In this regard, the signal may QPSK-modulated data transmitted from the transmitting apparatus 100. The receiving apparatus 200 checks a plurality of symbols included in the signal, detects at least one constellation combination pattern according to the plurality of symbols, and extracts additional data by using the constellation combination pattern. And then, the plurality of symbols is QPSK-modulated according to a different constellation combination pattern by predetermined unit. Accordingly, the receiving apparatus 200 may obtain original data.

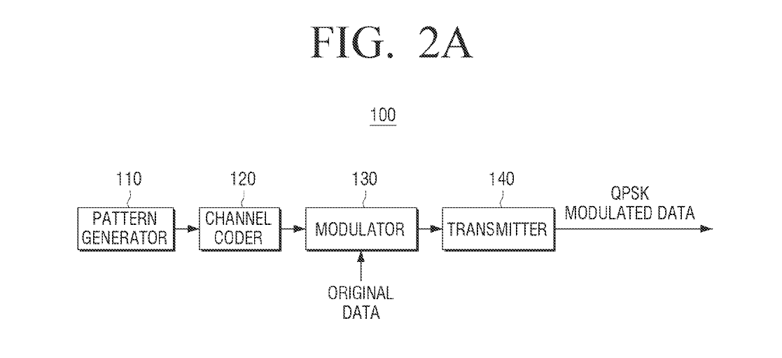

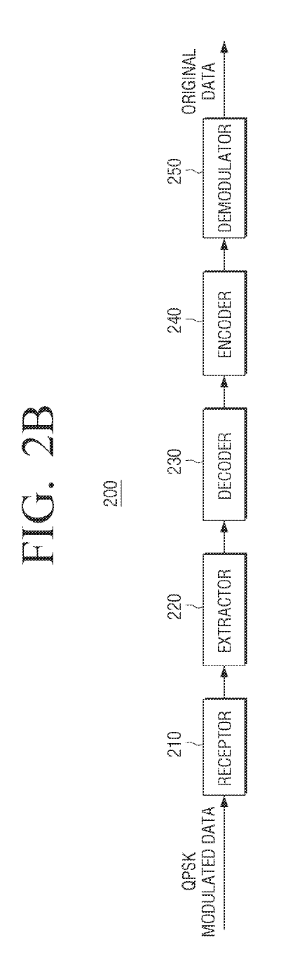

FIG. 2A and FIG. 2B are block diagrams illustrating a detailed configuration of a transmission and reception system according to an exemplary embodiment.

FIG. 2A is a block diagram illustrating a configuration of a transmitting apparatus according to an exemplary embodiment. Referring to FIG. 2, the transmitting apparatus 100 includes a pattern generator 110, a channel coder 120, a modulator 130, and a receptor 140.

The pattern generator 110 generates a constellation combination pattern by using at least one constellation. Desirably, a constellation may be plural, and the plurality of constellations may have different phases from each other.

The pattern generator 110 may combine a first constellation and a second constellation which has a 45 degree phase difference from the first constellation by predetermined unit regardless of an order and may generate a different constellation combination pattern by the predetermined unit.

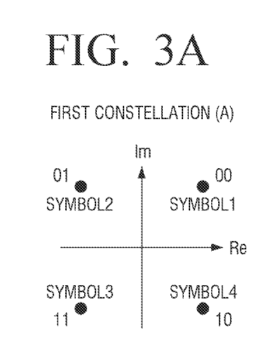

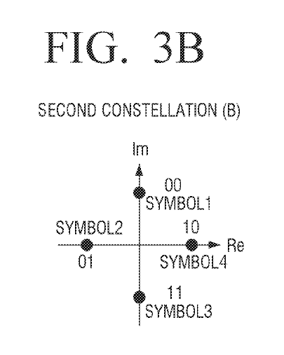

The first constellation and the second constellation will be described in detailed with reference to FIG. 3A and FIG. 3B. According to the present inventive concept, the first constellation and the second constellation may be QPSK-based constellations.

FIG. 3A is a view illustrating a first constellation and FIG. 3B is a view illustrating a second constellation.

Referring to FIG. 3A and FIG. 3B, a first constellation (a) and a second constellation (b) may include 4 symbols (symbols 1, 2, 3, and 4) respectively. In addition, one symbol may include information of 2-bit.

Symbols 1 to 4 which constitute the first constellation (a) have a 90 degrees phase difference among the neighboring symbols, and symbols 1 to 4 which constitute the second constellation (b) have a 90 degrees phase difference among the neighboring symbols.

In addition, the symbols 1 to 4 which constitute the first constellation (a) have a 45 degrees phase difference from the symbols 1 to 4 which constitute the second constellation (b). In this regard, the second constellation (b) may a constellation same as the first constellation (a) rotated by a phase of 45 degrees.

Meanwhile, the pattern generator 110 may generate a constellation combination pattern in a form which includes at least two constellations by combining the first constellation (a) and the second constellation (b) by predetermined unit regardless of an order. In this regard, at least one or more constellation combination patterns may be generated. If a plurality of constellation combination patterns is generated, the plurality of constellation combination patterns may have a different constellation combination pattern by predetermined unit.

For example, “ababab” which includes a constellation of 6 units may be generated by combining the first constellation (a) and the second constellation (b) three times alternately. In addition, “abaabb” which includes 6 constellations by combining the first constellation (a) and the second constellation (b) randomly may be included. In other words, “ababab” and “abaabb” may be constellation combination patterns, and the total number of constellations included in one constellation combination pattern may be a predetermined unit.

Meanwhile, the pattern generator 110 may combine the first constellation (a) and the second constellation (b) by using an orthogonal code such as the Walsh Code. Thus, if constellations are combined by using the Walsh Code, performance of receiving a signal in a receiving apparatus may be improved.

If the first constellation (a) and the second constellation (b) are combined, additional data according to each constellation combination pattern may be generated.

Specifically, the pattern generator 110 may regard each constellation combination pattern itself as one type of information, and the information may become additional data. That is, “ababab”, the constellation combination pattern, may become additional data for the pattern apart from additional data which is mapped to a and b.

For example, “ababab”, the constellation combination pattern, may be expressed as 1 (“ababab=1”) apart from original data which is mapped to a and b. In this regard, the additional data may be 1. Accordingly, if one constellation combination pattern is generated, additional data in response to the pattern may be generated.

In addition, since additional data is generated in response to one constellation combination pattern, the additional data may be hidden in original data which is mapped to the constellation combination pattern and be transmitted. Accordingly, if data of 2-bit is mapped to 6 constellations and transmitted previously, data of 12-bit is transmitted. But the transmitting apparatus 100 of the present inventive concept transmits data of 13-bit in total since the transmitting apparatus 100 transmits data of 12-bit by mapping data of 2-bit to 6 constellations, and a constellation combination pattern itself becomes additional data of 1-bit.

Meanwhile, additional data according to a constellation combination pattern may include information of 1-bit such as “0” or “1”, or may include information of 2-bit. In this regard, the number of bits which constitute the additional data may become different according to the number of constellation combination patterns.

For example, if the number of constellation combination patterns is 2, additional data may be 1-bit, and two types of additional data such as “0” and “1” may be possible. If the number of constellation combination patterns is 4, the additional data may be 2-bit. In other words, 4 types of additional data such as “00”, “01”, “11”, and “10” according to the 4 constellation combination patterns may be possible.

The channel coder 120 channel-codes additional data. In this regard, the channel coder 120 may channel-code additional data by using a Low Density Parity Check (LDPC) code, a Turbo code, and a convolutional code. By channel-coding the additional data like this, a signal receiving error which is generated in a receiving apparatus may be reduced by reducing effects caused by an interference signal generated in process of transmitting and receiving data and a fading phenomenon of a frequency.

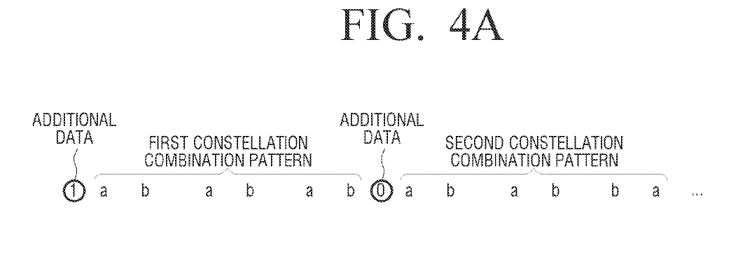

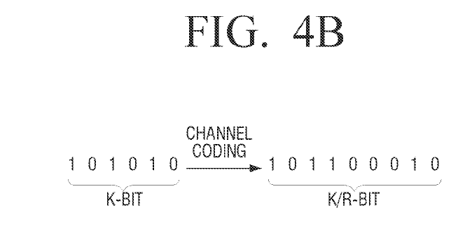

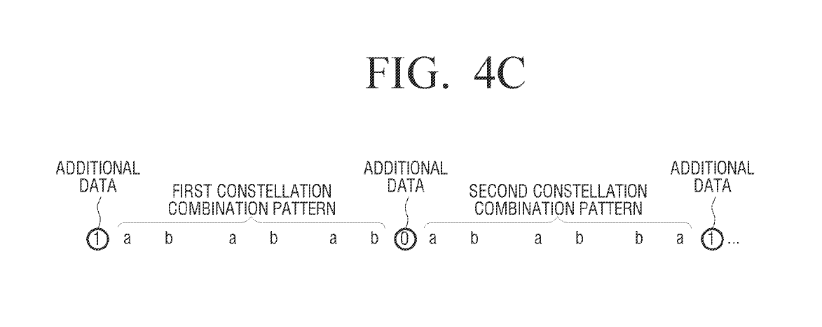

A method of channel-coding will be described in detail with reference to FIGS. 4A to 4C.

FIG. 4A to FIG. 4C are views illustrating a method of channel-coding additional data according to an exemplary embodiment.

Referring to FIG. 4A, a first constellation combination pattern and a second constellation combination patter are illustrated. The first and the second constellation combination patterns are combinations of the first constellation (a) and the second constellation (b) by 6-unit and have patterns of “ababab” and “ababba”, respectively. In addition, original data may be mapped to each of the constellations which constitute the first and the second constellation combination patterns by 2-bit unit.

Meanwhile, additional data may be generated according to the combination of the first constellation (a) and the second constellation (b). Accordingly, additional data according to the first constellation combination pattern may become “1”, and additional data according to the second constellation combination pattern may become “0”. Such additional data may be channel-coded before transmission.

Referring to FIG. 4B, if three of the first constellation combination patterns and three of the second constellation combination patterns are arranged alternately, additional data may be included in each of the constellation combination patterns. Additional data “1” may be included in the first constellation combination pattern, and additional data “0” may be included in the second constellation combination pattern. Accordingly, additional data for the six constellation combination patterns in total may be 6-bit (K) as “1”, “0”, “1”, “0”, “1”, and “0”, and the additional data may be channel-coded by using a convolutional code of which code rate is R. Additional data which is channel-coded according to the code rate (R) may be 6/R bit (K/R). In this regard, it is desirable that the code rate (R) be less than 1. In FIG. 4B, the code rate (R) is ⅔, and if additional data of 6-bit in total is channel-coded by using the code rate (R), the additional data may increase to 9-bit.

Referring to FIG. 4C, the additional data increased to 9-bit according to the channel-coding becomes “1”, “0”, “1”, “1”, “0”, “0”, “0”, “1”, and “0”, and a constellation combination pattern corresponding to a bit value of each of the additional data between a first constellation and a second constellation combination patterns is applied. For example, the additional data of “1” is applied with the first constellation combination pattern and the additional data of “0” is applied with the second constellation combination pattern.

The method of channel-coding by using a convolutional code was described in FIGS. 4A to 4C, but additional data may be channel-coded by using a LDPC code or a Turbo code.

The modulator 130 performs a QPSK-modulation for original data by using a different constellation combination pattern by predetermined unit. Original data consists of a number of bits, and the prescribed number of bits may be mapped to at least one symbol of each of constellations which constitute a constellation combination pattern. Accordingly, if channel-coded additional data and a constellation combination pattern in accordance with the data are received, the modulator 130 may QPSK-modulate the original data by using the constellation combination pattern.

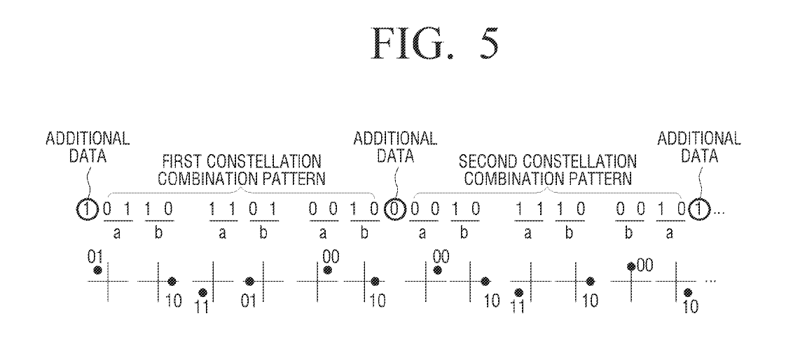

Specifically, the modulator 130 may map by 2-bit unit original data to at least one symbol included in a first constellation and a second constellation respectively according to a combination order of the first constellation and the second constellation which constitute a constellation combination pattern. Such modulation method will be described in detailed with reference to FIG. 5.

FIG. 5 is a view illustrating a mapping form of original data using a constellation combination pattern according to an exemplary embodiment.

Referring to FIG. 5, a constellation combination pattern according to channel-coded additional data is illustrated as shown in FIG. 4C. A first constellation combination pattern is a combination of the first constellation (a) and the second constellation (b) by 6-unit, and has a pattern of “ababab”. Original data may be mapped to each of the constellations which constitute the first constellation combination pattern by 2-bit unit.

For example, if original data is “011011010010001011100010 . . . ”, the original data may be mapped by 2-bit unit according to an order of a constellation which constitutes the first and the second constellation combination patterns.

“01” which is a first 2-bit of original data may be mapped to the first constellation (a) which is located first in the first constellation combination pattern. In this regard, “01” may be mapped to a symbol which corresponds to “01” in the first constellation (a). Through such method, original data may be mapped to other constellations which are arranged subsequently.

The transmitter 140 transmits QPSK-modulated data to a receiving apparatus. In this regard, channel-coded additional data may be included in the QPSK-modulated data.

As described above, according to the present inventive concept, the transmitting apparatus 100 may transmit additional data in hidden form by using a constellation combination pattern.

FIG. 2B is a block diagram illustrating a configuration of a receiving apparatus according to an exemplary embodiment. Referring to FIG. 2B, the receiving apparatus 200 includes a receptor 210, an extractor 220, a decoder 230, an encoder 240, and a demodulator 250.

The receiving apparatus 200 may know information related to a constellation combination pattern. The transmitting apparatus 100 may provide the constellation combination pattern and the relevant information (for example, a type of a constellation which constitutes a constellation combination pattern, the number of constellations, and a combination order of the constellations) to the receiving apparatus 200 by communicating with the receiving apparatus 200 before transmitting the QPSK-modulated data to the receiving apparatus 200. Accordingly, the receiving apparatus 200 may detect a constellation combination pattern by using a type of constellations (the first constellation (a) and the second constellation (b)), the number of the constellations and a combination order of the constellations.

The receptor 210 receives a signal from the transmitting apparatus 100. The signal as QPSK-modulated data transmitted from the transmitting apparatus 100 may include a plurality of symbols. In addition, original data may be mapped to each of the plurality of symbols.

The extractor 220 checks the plurality of symbols included in the signal, detects at least one constellation combination pattern according to the plurality of symbols, and extracts additional data according to the constellation combination pattern.

Specifically, the extractor 220 may calculate an accumulated value of a minimum Euclid distance between each of the plurality of symbols and at least one or more of the constellations, and may select a constellation which has the smallest accumulated value as a constellation for a target symbol among the plurality of symbols.

In addition, the extractor 220 may detect at least one constellation combination pattern by using the selected constellation corresponding to each of the plurality of symbols respectively, and may extract additional data by determining the number of bits of additional data from the detected constellation combination pattern. As described above, the receiving apparatus 200 knows a type, the number, and a combination order of a constellation which constitutes a constellation combination pattern. Accordingly, the extractor 220, if a plurality of constellations for the plurality of symbols is selected, may detect a constellation combination pattern by dividing the plurality of constellations by unit of the number of constellations which constitute the constellation combination pattern. Additional data may be extracted according to whether the constellation combination pattern is a first constellation combination pattern or a second constellation combination pattern. In this regard, the additional data is channel-coded before being transmitted from the transmitting apparatus 100 and the probability of extracting additional data may be increased by the channel-coding.

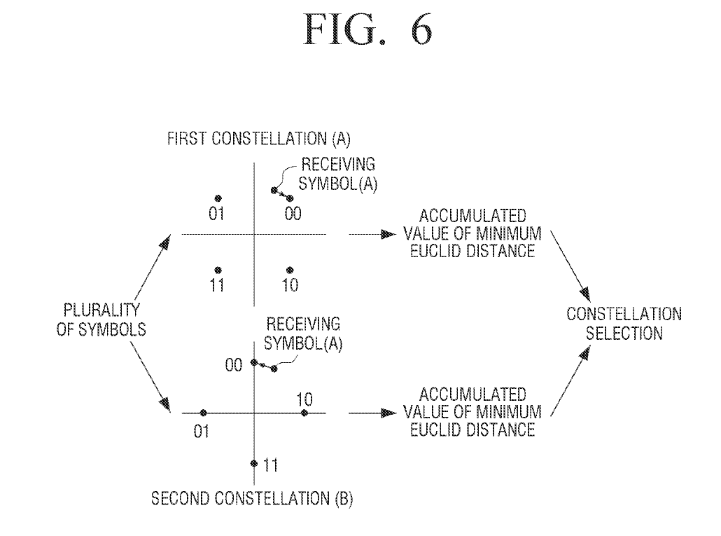

FIG. 6 is a view illustrating a method of extracting additional data according to an exemplary embodiment.

Referring to FIG. 6, an accumulated value of a minimum Euclid distance between each of a plurality of symbols included in a receiving signal and the first and the second constellations (a and b) is calculated. Specifically, a minimum Euclid distance between a receiving symbol (A) which is a target among the plurality of symbols (hereinafter, referred as ‘a target symbol’) and the first constellation (a) is calculated. A minimum Euclid distance between the target symbol (A) and the second constellation (b) is calculated.

In this regard, a constellation where an accumulated value of a minimum Euclid distance is the smallest may be selected as a constellation for the target symbol (A). Through such method, a constellation combination pattern may be detected by selecting the selected constellations and by dividing the constellations by unit of the number of constellations which constitute a constellation combination pattern. Thus, if a constellation combination pattern is detected, additional data according to the constellation combination pattern may be extracted. For example, when a first constellation combination pattern is detected, “1” may be extracted as additional data, and when a second constellation combination pattern is detected, “0” may be extracted as additional data.

In the receiving apparatus 200 illustrated in FIG. 2A, the decoder 230 decodes extracted additional data. When decoding the additional data, additional data of K/R bit may be K-bit.

For example, as illustrated in FIG. 4B, additional data may become 9(K/R)-bit in total by channel-coding. Thus, when the channel-coded additional data is decoded in the receiving apparatus 200, additional data of 6-bit before the channel-coding may be found accurately.

If the plurality of symbols is demodulated by using a constellation combination pattern according to the decoded additional data, the receiving apparatus 100 may not obtain data which corresponds to the QPSK-modulated data transmitted from the transmitting apparatus 100. In other words, it is because the decoded additional data is 6-bit, and the QPSK-modulated data corresponds to the additional data of 9-bit.

Accordingly, the encoder 240 encodes the decoded additional data and makes it additional data of K/R-bit in order to demodulate the plurality of symbols by using a constellation combination pattern for the additional data of K/R-bit.

The demodulator 250 performs a QPSK-demodulation for a plurality of symbols according to a constellation combination pattern. Specifically, from a constellation combination pattern for additional data of K/R-bit, a symbol mapped to each of the constellations which constitutes the constellation combination pattern may be detected. For example, if a first constellation combination pattern is “ababab”, data of 2-bit may be obtained by performing a QPSK-modulation for a symbol mapped to the first constellation (a) located first. In addition, data of 2-bit may be obtained by QPSK-modulating a symbol mapped to the second constellation (b) located second. Through such methods, data of 12-bit and additional data of 1-bit may be obtained when modulating a symbol mapped to 6 constellations which constitute the first constellation combination pattern.

In addition, original data for the QPSK-modulated data may be obtained by applying the above-described method to a constellation combination pattern for additional data of K/R-bit.

As described above, according to the present inventive step, the receiving apparatus 200 may check a plurality of symbols, detect a constellation combination pattern, and extract additional data from the pattern. In the process, by decoding and encoding additional data, the accuracy of the additional data extraction may be improved, and original data corresponding to the QPSK-modulated data transmitted from the transmitting apparatus 100 may be obtained.

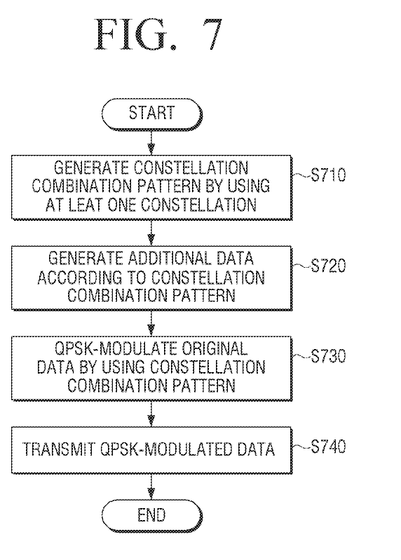

FIG. 7 is a flow chart illustrating a method of transmitting a signal according to an exemplary embodiment. Referring to FIG. 7, the method of transmitting a signal generates a constellation combination pattern by using at least one constellation (S710). For example, a constellation combination pattern may be generated by combining by predetermined unit regardless of an order a first constellation and a second constellation which have different phases from each other.

Subsequently, the method of transmitting a signal generates additional data according to a constellation combination pattern (S720).

In the meantime, the method of transmitting a signal performs a QPSK-modulation for original data by using a different constellation combination pattern by predetermined unit (S730). Specifically, a constellation combination pattern consists of a first constellation and a second constellation, and the first constellation and the second constellation may include 4 symbols. Accordingly, by mapping original data by prescribed-bit unit to a symbol included in the first constellation and the second constellation which are arranged according to the constellation combination pattern, the original data may be modulated.

The method of transmitting a signal transmits QPSK-modulated data to the receiving apparatus 200 (S740). In the process, additional data may be transmitted in hidden form to the QPSK-modulated data.

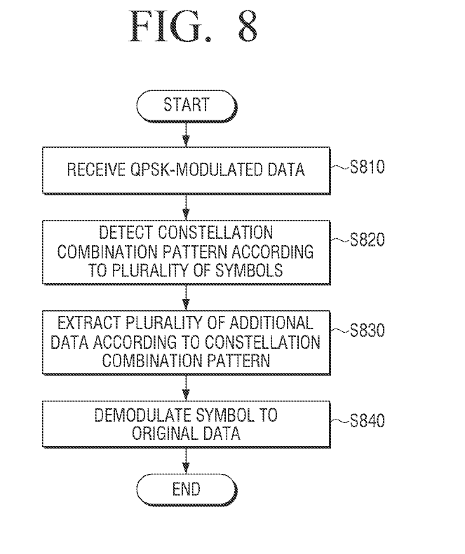

FIG. 8 is a flow chart illustrating a method of receiving a signal according to an exemplary embodiment. Referring to FIG. 7, the method of receiving a signal receives a signal from the transmitting apparatus 100. In this regard, the signal may be the QPSK-modulated data transmitted from the transmitting apparatus 100.

Subsequently, the method of receiving a signal checks a plurality of symbols included in a signal and detects at least one constellation combination pattern according to the plurality of symbols (S820). The constellation combination pattern may be detected by calculating an accumulated value of a minimum Euclid distance between each of the plurality of symbols and at least one constellation which constitutes the constellation combination pattern.

Meanwhile, the method of receiving a signal extracts a plurality of additional data according to a constellation combination pattern (S830).

The method of receiving a signal demodulates a plurality of symbols to original data (S840). In other words, by detecting a constellation combination pattern and de-mapping a plurality of symbols which constitute the constellation combination pattern, original data mapped to the plurality of symbols may be demodulated.

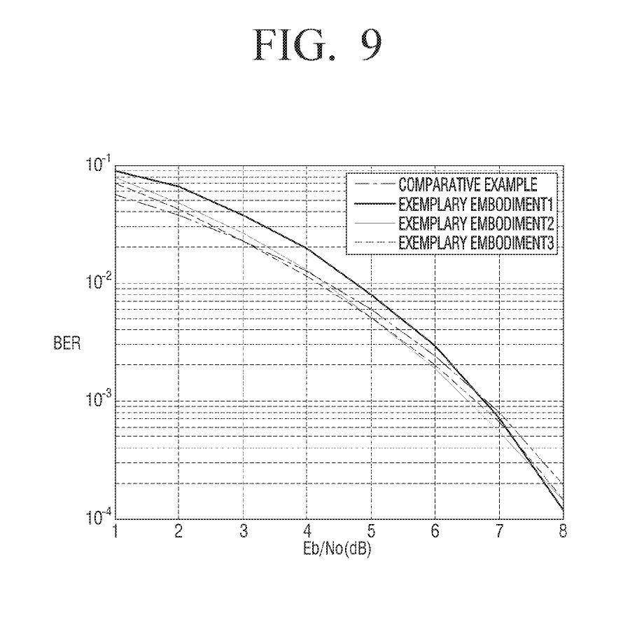

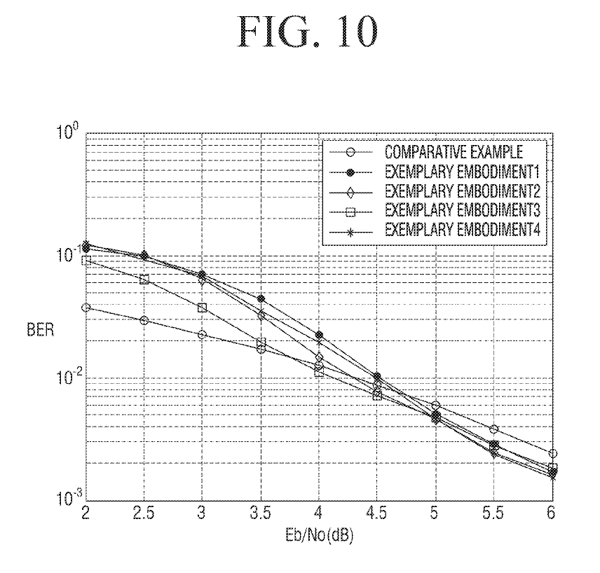

FIG. 9 and FIG. 10 are graphs where a Bit Error Rate (BER) and Eb/N0 are measured when transmitting data according to a comparative example and exemplary embodiments.

FIG. 9 is a graph which shows a result of transmitting the QPSK-modulated data according to exemplary embodiments 1 to 3 through a Additive White Gaussian Noise (AWGN) channel by using the transmitting apparatus 100 illustrated in FIG. 2A and the QPSK modulated data according to a comparative example which was modulated by the existing method.

Referring to FIG. 9, original data may be mapped to a symbol which constitutes a constellation combination pattern. However, exemplary embodiments 1 to 3 are only different in a constellation combination pattern used for modulating original data, and the exemplary embodiments are modulated in the same way.

Specifically, exemplary embodiment 1 used a constellation combination pattern of 5-unit and exemplary embodiment 2 used a constellation combination pattern of 10-unit. Exemplary embodiment 3 used a constellation combination pattern of 15-unit.

Considering that original data of 2-bit is mapped to a symbol of a constellation, exemplary embodiments 1 to 3 may become 10-bit, 20-bit, and 30-bit, respectively, and additional data generated according to each of the constellation combination pattern may be transmitted at every 10-bit, 20-bit, and 30-bit interval.

For example, as exemplary embodiment 1, if a constellation combination pattern of 5-unit is “aaaaa” where 5 of the first constellations (a) are combined, additional data may become 1. In addition, if a constellation combination pattern of 5-unit is “bbbbb” where 5 of the second constellations (b) are combined, the additional data may become 0.

Thus, as exemplary embodiment 2, when a constellation combination pattern of 10-unit is “aaaaaaaaaa” where ten of the first constellations (a) are combined, the additional data may become 1 and when the constellation combination pattern of 10-unit is “bbbbbbbbbb” where ten of the second constellations (b) are combined, the additional data may become 0.

As exemplary embodiment 3, when a constellation combination pattern of 15-unit is “aaaaaaaaaaaaaaa” where 15 of the first constellations (a) are combined, the additional data may become 1, and when the constellation combination pattern of 15-unit is “bbbbbbbbbbbbbbb” where 15 of the second constellations (b) are combined, the additional data may become 0.

Referring to FIG. 9, BER performance of exemplary embodiments 1 to 3 is improved compared with a comparative example when Eb/No is 7 dB or more than 7 dB. In addition, it may be found out that according to a unit of a constellation combination pattern used for modulating original data, Eb/No where the BER performance is improved compared with that of a comparative example becomes different.

FIG. 10 is a graph showing a result of transmitting the QPSK-modulated data which is modulated according to the existing method and the QPSK-modulated data according to exemplary embodiments 1 to 4 which is modulated by using the transmitting apparatus 100 illustrated in FIG. 2A through a Additive White Gaussian Noise (AWGN) channel. In this case, the QPSK-modulated data may be where original data is mapped to each constellation which constitutes a constellation combination pattern. In other words, the QPSK-modulated data may include a symbol where original data is mapped.

When using a constellation combination pattern, additional data according to the constellation combination pattern may be generated. In FIG. 10, additional data included in the QPSK-modulated data according to exemplary embodiments 1 to 4 was encoded with a convolutional code and the QPSK-modulated data was transmitted.

Exemplary embodiments 1 to 4 are only different in a unit of a constellation combination pattern used for modulating original data, but are modulated in the same way. Specifically, exemplary embodiments 1 and 2 used constellation combination patterns of 6-unit (“aaaaaa” and “bbbbbb”), and exemplary embodiment 3 used a constellation combination pattern of 8-unit (“aaaaaaaa” and “bbbbbbbb”). In addition, exemplary embodiment 4 used a constellation combination pattern of 5-unit ((“aaaaa” and “bbbbb”). In this regard, a is a first constellation and b is a second constellation.

In addition, additional data is encoded with a convolutional code of ½ in exemplary embodiment 1, and additional data is encoded with a convolutional code of ⅓ in exemplary embodiment 2. Additional data is encoded with a convolutional code of ¼ in exemplary embodiment 3, and additional data is encoded with a convolutional code of ⅕ in exemplary embodiment 4.

According to FIG. 10, the BEP performance of exemplary embodiments 1 to 4 is improved compared with that of the comparative example when Eb/No is 4.7 dB or more than 4.7 dB. In addition, it may be found out that even though the same constellation combination pattern is used, Eb/No where the BER is improved compared with that of the comparative example becomes different according to a code rate.

A method of transmitting and receiving a signal according to the exemplary embodiment may be embodied as a program which includes an algorithm executable in a computer, and the program may be stored in a non-transitory computer readable medium and provided.

The non-transitory readable medium does not refer to a medium storing data for a short moment such as a register, a cache, or a memory, but refers to a medium which is capable of storing data semi-permanently and reading the data by an apparatus. Specifically, the above-described various types of programs may be stored in the non-transitory readable medium such as be a compact disc (CD), a digital versatile disk (DVD), a hard disk, a Blu-ray disk, a universal serial bus (USB), a memory card, and a read only memory (ROM) and provided.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A transmitting apparatus comprising:
a modulator configured to perform a Quadrature Phase Shift Keying (QPSK) modulation by using a different constellation for original data by predetermined unit; and
a transmitter configured to transmit the QPSK-modulated data.

2. The apparatus as claimed in claim 1, further comprising:
a pattern generator configured to generate a different combination pattern by the predetermined unit by combining a first constellation and a second constellation by the predetermined unit regardless of an order, and configured to generate additional data according to the constellation combination pattern.

3. The apparatus as claimed in claim 2, wherein the pattern generator combines the first constellation and the second constellation by using a Walsh Code.

4. The apparatus as claimed in claim 2, further comprising:
a channel coder which channel-codes the generated additional data.

5. The apparatus as claimed in claim 4, wherein the modulator generates the QPSK-modulated data by adding the channel-coded additional data to the original data.

6. The apparatus as claimed in claim 2, wherein the modulator maps by 2-bit unit the original data to at least one symbol included in the first constellation and the second constellation respectively according to a combination order of the first constellation and the second constellation which constitute the constellation combination pattern.

7. The apparatus as claimed in claim 2, wherein the first constellation has a phase difference of 45 degrees from the second constellation.

8. A receiving apparatus comprises:
a receiver configured to receive a signal from a transmitting apparatus;
a extractor configured to check a plurality of symbols included in the signal, detects at least one constellation combination pattern according to the plurality of symbols, and extracts additional data according to the constellation combination pattern; and
a demodulator configured to QPSK-demodulate the plurality of symbols according to at least the one constellation combination pattern.

9. A transmitting method comprises:
QPSK-modulating original data by using a different constellation combination pattern by predetermined unit; and
transmitting the QPSK-modulated data.

10. The method as claimed in claim 9, further comprising:
generating a different constellation combination pattern by the predetermined unit by combining a first constellation and a second constellation by the predetermined unit regardless of an order, and generating additional data according to the constellation combination pattern.

11. The method as claimed in claim 10, wherein the generating additional data includes generating the constellation combination pattern by combining the first constellation and the second constellation by using a Walsh Code.

12. The method as claimed in claim 10, further comprising:
channel-coding the generated additional data.

13. The method as claimed in claim 12, wherein the QPSK-modulating includes generating the QPSK-modulated data by adding the channel-coded additional data to the original data.

14. The transmitting apparatus as claimed in claim 10, wherein the QPSK-modulating includes mapping by 2-bit unit the original data to at least one symbol included in the first constellation and the second constellation respectively according to an combination order of the first constellation and the second constellation which constitute the constellation combination pattern.

15. A signal receiving method comprising:
receiving a signal from a transmitting apparatus;
checking a plurality of symbols included in the signal, detecting at least one constellation combination pattern according to the plurality of symbols, and extracting additional data according to the constellation combination pattern; and
QPSK-demodulating the plurality of symbols according to at least the one constellation combination pattern.
